(19) United States
(12) Patent Application Publication
(10) Pub. No.: US 2026/0039347 A1
(43) Pub. Date: Feb. 5, 2026

(54) CHANNEL STATE INFORMATION FEEDBACK FOR DIFFERENT CODEWORD TO LAYER MAPPING SCHEMES

(71) Applicant: QUALCOMM Incorporated, San Diego, CA (US)

(72) Inventors: Pinar SEN, San Diego, CA (US); Wei YANG, San Diego, CA (US); Kirill IVANOV, La Jolla, CA (US); Jing JIANG, San Diego, CA (US); Yu ZHANG, San Diego, CA (US); Jing SUN, San Diego, CA (US)

(21) Appl. No.: 18/790,825

(22) Filed: Jul. 31, 2024

(51) Int. Cl. H04B 7/06; H04B 7/0456

(52) U.S. Cl. CPC H04B 7/0626; H04B 7/0473

(57) ABSTRACT

Methods, systems, and devices for wireless communication are described. The method may include a user equipment (UE) receiving a set of channel state information (CSI) reference signals (CSI-RSs) and transmitting CSI based on the received set of CSI-RSs, where the CSI includes information that indicates an order of a set of spatial layers that is based on relative signal strengths associated with the set of spatial layers. Additionally, the method may include the UE transmitting a set of codewords based on a mapping between each codeword of the set of codewords and each spatial layer of the set of spatial layers.

### FIELD OF TECHNOLOGY

The following relates to wireless communication, including channel state information (CSI) feedback for different codeword to layer mapping schemes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Devices of a wireless communications system may support multiple-input multiple-output (MIMO). Using MIMO, the devices may transmit or receive multiple streams of data via same time and frequency resource using two or more spatial layers (e.g., two or more antennas).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a set of channel state information (CSI) reference signals (CSI-RSs), transmitting CSI based on the received set of CSI-RSs, the CSI including information that indicates an order of a set of spatial layers, where the order is based on relative signal strengths associated with the set of spatial layers, and transmitting a set of codewords based on a mapping between each codeword of the set of codewords and each spatial layer of the set of spatial layers.

A UE for wireless communications is described. The UE may include one or more memories storing processor executable code, and one or more processors coupled with the one or more memories. The one or more processors may individually or collectively be operable to execute the code to cause the UE to receive a set of CSI-RSs, transmit CSI based on the received set of CSI-RSs, the CSI including information that indicates an order of a set of spatial layers, where the order is based on relative signal strengths associated with the set of spatial layers, and transmit a set of codewords based on a mapping between each codeword of the set of codewords and each spatial layer of the set of spatial layers.

Another UE for wireless communications is described. The UE may include means for receiving a set of CSI-RSs, means for transmitting CSI based on the received set of CSI-RSs, the CSI including information that indicates an order of a set of spatial layers, where the order is based on relative signal strengths associated with the set of spatial layers, and means for transmitting a set of codewords based on a mapping between each codeword of the set of codewords and each spatial layer of the set of spatial layers.

A non-transitory computer-readable medium storing code for wireless communications is described. The code may include instructions executable by one or more processors to receive a set of CSI-RSs, transmit CSI based on the received set of CSI-RSs, the CSI including information that indicates an order of a set of spatial layers, where the order is based on relative signal strengths associated with the set of spatial layers, and transmit a set of codewords based on a mapping between each codeword of the set of codewords and each spatial layer of the set of spatial layers.

Some examples of the method, UEs, and non-transitory computer-readable medium described herein may further include operations, features, means, or instructions for receiving a configuration that indicates a codeword-to-spatial layer mapping, where the mapping between each codeword of the set of codewords and each spatial layer of the set of spatial layers may be based on the received configuration.

Some examples of the method, UEs, and non-transitory computer-readable medium described herein may further include operations, features, means, or instructions for selecting a codeword-to-spatial layer mapping scheme from a set of multiple mapping schemes, where the mapping between each codeword of the set of codewords and each spatial layer of the set of spatial layers may be based on the selected codeword-to-spatial layer mapping scheme and transmitting an indication of the selected codeword-to-spatial layer mapping scheme.

Some examples of the method, UEs, and non-transitory computer-readable medium described herein may further include operations, features, means, or instructions for transmitting capability information that indicates a supported codeword-to-spatial layer mapping scheme, where the mapping between each codeword of the set of codewords and each spatial layer of the set of spatial layers may be based on the transmitted capability information.

Some examples of the method, UEs, and non-transitory computer-readable medium described herein may further include operations, features, means, or instructions for receiving an indication to switch from a first codeword-to-spatial layer mapping scheme to a second codeword-to-spatial layer mapping scheme, where the mapping between each codeword of the set of codewords and each spatial layer of the set of spatial layers may be based on the received indication.

In some examples of the method, UEs, and non-transitory computer-readable medium described herein, the order indicates that a first spatial layer of the set of spatial layers may be associated with a signal strength that may be greater than a signal strength associated with a second spatial layer of the set of spatial layers.

In some examples of the method, UEs, and non-transitory computer-readable medium described herein, the order further indicates that a third spatial layer of the set of spatial layers may be associated with a signal strength that may be less than the signal strength associated with the first spatial layer and greater than the signal strength associated with the second spatial layer.

In some examples of the method, UEs, and non-transitory computer-readable medium described herein, transmitting the set of codewords may include operations, features, means, or instructions for transmitting, during a first duration, a first portion of a codeword of the set of codewords using the first spatial layer and transmitting, during a second duration, the first portion of the codeword using the second spatial layer and a second portion of the codeword using the first spatial layer.

In some examples of the method, UEs, and non-transitory computer-readable medium described herein, the order indicates that a first spatial layer and a second spatial layer of the set of spatial layers may be associated with a stronger signal strength compared to a signal strength of a third spatial layer and a fourth spatial layer of the set of spatial layers.

In some examples of the method, UEs, and non-transitory computer-readable medium described herein, transmitting the set of codewords may include operations, features, means, or instructions for transmitting, during a first duration, a first portion of a codeword of the set of codewords using the first spatial layer and the second spatial layer and transmitting, during a second duration, the first portion of the codeword using the third spatial layer and the fourth spatial layer and a second portion of the codeword using the first spatial layer and the second spatial layer.

Some examples of the method, UEs, and non-transitory computer-readable medium described herein may further include operations, features, means, or instructions for identifying a first codeword-to-spatial layer mapping scheme, where the CSI may be based on the identified first codeword-to-spatial layer mapping scheme, identifying a second codeword-to-spatial layer mapping scheme different from the first codeword-to-spatial layer mapping scheme, and generating second CSI, where the second CSI may be based on the identified second codeword-to-spatial layer mapping scheme.

Some examples of the method, UEs, and non-transitory computer-readable medium described herein may further include operations, features, means, or instructions for transmitting the second CSI.

Some examples of the method, UEs, and non-transitory computer-readable medium described herein may further include operations, features, means, or instructions for transmitting signaling indicative of a difference between the CSI and the second CSI.

In some examples of the method, UEs, and non-transitory computer-readable medium described herein, one or more parameters included in the CSI may be equal to one or more parameters included in the second CSI.

In some examples of the method, UEs, and non-transitory computer-readable medium described herein, the mapping between each codeword of the set of codewords and each spatial layer of the set of spatial layers may be based on the CSI and the second CSI.

A method for wireless communications by a network entity is described. The method may include transmitting a set of CSI-RSs, receiving CSI based on transmitting the set of CSI-RSs, the CSI including information that indicates an order of a set of spatial layers, where the order is based on relative signal strengths of the set of spatial layers, and receiving a set of codewords based on a mapping between each codeword of the set of codewords and each spatial layer of the set of spatial layers.

A network entity for wireless communications is described. The network entity may include one or more memories storing processor executable code, and one or more processors coupled with the one or more memories. The one or more processors may individually or collectively be operable to execute the code to cause the network entity to transmit a set of CSI-RSs, receive CSI based on transmitting the set of CSI-RSs, the CSI including information that indicates an order of a set of spatial layers, where the order is based on relative signal strengths of the set of spatial layers, and receive a set of codewords based on a mapping between each codeword of the set of codewords and each spatial layer of the set of spatial layers.

Another network entity for wireless communications is described. The network entity may include means for transmitting a set of CSI-RSs, means for receiving CSI based on transmitting the set of CSI-RSs, the CSI including information that indicates an order of a set of spatial layers, where the order is based on relative signal strengths of the set of spatial layers, and means for receiving a set of codewords based on a mapping between each codeword of the set of codewords and each spatial layer of the set of spatial layers.

A non-transitory computer-readable medium storing code for wireless communications is described. The code may include instructions executable by one or more processors to transmit a set of CSI-RSs, receive CSI based on transmitting the set of CSI-RSs, the CSI including information that indicates an order of a set of spatial layers, where the order is based on relative signal strengths of the set of spatial layers, and receive a set of codewords based on a mapping between each codeword of the set of codewords and each spatial layer of the set of spatial layers.

Some examples of the method, network entities, and non-transitory computer-readable medium described herein may further include operations, features, means, or instructions for transmitting a configuration that indicates a codeword-to-spatial layer mapping scheme, where the mapping between each codeword of the set of codewords and each spatial layer of the set of spatial layers may be based on the transmitted configuration.

Some examples of the method, network entities, and non-transitory computer-readable medium described herein may further include operations, features, means, or instructions for receiving an indication of a codeword-to-spatial layer mapping scheme preferred by a UE, where the mapping between each codeword of the set of codewords and each spatial layer of the set of spatial layers may be based on the received indication.

Some examples of the method, network entities, and non-transitory computer-readable medium described herein may further include operations, features, means, or instructions for receiving capability information that indicates a supported codeword-to-spatial layer mapping scheme, where the mapping between each codeword of the set of codewords and each spatial layer of the set of spatial layers may be based on the received capability information.

Some examples of the method, network entities, and non-transitory computer-readable medium described herein may further include operations, features, means, or instructions for transmitting an indication to switch from a first codeword-to-spatial layer mapping scheme to a second codeword-to-spatial layer mapping scheme, where the mapping between each codeword of the set of codewords and each spatial layer of the set of spatial layers may be based on the transmitted indication.

In some examples of the method, network entities, and non-transitory computer-readable medium described herein, the order indicates that a first spatial layer of the set of spatial layers may be associated with a signal strength that may be greater than a signal strength associated with a second spatial layer of the set of spatial layers.

In some examples of the method, network entities, and non-transitory computer-readable medium described herein, the order further indicates that a third spatial layer of the set of spatial layers may be associated with a signal strength that may be less than the signal strength associated with the first spatial layer and greater than the signal strength associated with the second spatial layer.

Some examples of the method, network entities, and non-transitory computer-readable medium described herein may further include operations, features, means, or instructions for receiving, during a first duration, a first portion of a codeword of the set of codewords and receiving, during a second duration, a second portion of the codeword based on the received first portion of the codeword.

In some examples of the method, network entities, and non-transitory computer-readable medium described herein, the order indicates that a first spatial layer and a second spatial layer of the set of spatial layers may be associated with a stronger signal strength compared to a signal strength of a third spatial layer and a fourth spatial layer of the set of spatial layers.

In some examples of the method, network entities, and non-transitory computer-readable medium described herein, the CSI corresponds to a first codeword-to-spatial layer mapping scheme and the method, apparatuses, and non-transitory computer-readable medium may include further operations, features, means, or instructions for receiving second CSI, where the second CSI corresponds to a second codeword-to-spatial layer mapping scheme.

In some examples of the method, network entities, and non-transitory computer-readable medium described herein, one or more parameters included in the CSI may be equal to one or more parameters included in the second CSI.

In some examples of the method, network entities, and non-transitory computer-readable medium described herein, the mapping between each codeword of the set of codewords and each spatial layer of the set of spatial layers may be based on the CSI and the second CSI.

In some examples of the method, network entities, and non-transitory computer-readable medium described herein, the CSI correspond to a first code-to-spatial layer mapping scheme and the method, apparatuses, and non-transitory computer-readable medium may include further operations, features, means, or instructions for receiving signaling indicative of a difference between the CSI and second CSI, where the second CSI corresponds to a second codeword-to-spatial layer mapping scheme.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports channel state information (CSI) feedback for different codeword to layer mapping schemes in accordance with one or more aspects of the present disclosure.

FIG. 2 shows an example of a wireless communications system that supports CSI feedback for different codeword to layer mapping schemes in accordance with one or more aspects of the present disclosure.

FIGS. 3A, 3B, and 3C show examples of a mapping technique that supports CSI feedback for different codeword to layer mapping schemes in accordance with one or more aspects of the present disclosure.

FIG. 4 shows an example of a multiple-input multiple-output (MIMO) transmission that supports CSI feedback for different codeword to layer mapping schemes in accordance with one or more aspects of the present disclosure.

FIG. 5 shows an example of a process flow that supports CSI feedback for different codeword to layer mapping schemes in accordance with one or more aspects of the present disclosure.

FIGS. 6 and 7 show block diagrams of devices that support CSI feedback for different codeword to layer mapping schemes in accordance with one or more aspects of the present disclosure.

FIG. 8 shows a block diagram of a communications manager that supports CSI feedback for different codeword to layer mapping schemes in accordance with one or more aspects of the present disclosure.

FIG. 9 shows a diagram of a system including a device that supports CSI feedback for different codeword to layer mapping schemes in accordance with one or more aspects of the present disclosure.

FIGS. 10 and 11 show block diagrams of devices that support CSI feedback for different codeword to layer mapping schemes in accordance with one or more aspects of the present disclosure.

FIG. 12 shows a block diagram of a communications manager that supports CSI feedback for different codeword to layer mapping schemes in accordance with one or more aspects of the present disclosure.

FIG. 13 shows a diagram of a system including a device that supports CSI feedback for different codeword to layer mapping schemes in accordance with one or more aspects of the present disclosure.

FIGS. 14 through 17 show flowcharts illustrating methods that support CSI feedback for different codeword to layer mapping schemes in accordance with one or more aspects of the present disclosure.

### DETAILED DESCRIPTION

In some examples, devices of a wireless communications system (e.g., a user equipment (UE) or a network entity) may multiple-input multiple-output (MIMO) communication. To support MIMO communication, a first device (e.g., the UE) of the wireless communications system may transmit a codeword using two or more spatial layers. The first device may map the codeword to the two or more spatial layers using a mapping scheme. For example, using a first mapping scheme, the first device may transmit, to a second device (e.g., the network entity), a first portion of the codeword via a first spatial layer during a first duration and a second portion of the codeword via the first spatial layer and a duplicate of the first portion of the codeword via the second layer during a second duration.

To decode the codeword mapped according to the first mapping scheme, the second device may decode the first portion of the codeword received via signaling during the first duration and utilize the first portion of the codeword to decode the second portion of the codeword received via signaling during the second duration. It may be beneficial for the devices to have knowledge of an order of relative strengths of the spatial layer such that the devices may accurately map the portions of the codewords to appropriate layers (e.g., map a first occurrence of the portion of a codeword to a stronger spatial layer) which may aid in the decoding of the codeword.

As described herein, devices of the wireless communications system may gain knowledge of the order of the relative strengths of the spatial layers to increase the reliability of MIMO communications. In some examples, the first device may be configured with the first mapping scheme (e.g., via signaling from the second device). Upon being configured with the first mapping scheme, the first device may receive a set of reference signals (e.g., a set of channel state information (CSI) reference signals (CSI-RSs)) from the second device and generate CSI based on the first mapping scheme and measurements of the received set of reference signals. In some examples, the CSI may include information indicating the order of the spatial layers (e.g., from strongest to weakest).

Further, the first device may transmit a report to the second device indicating the CSI. At a later time, the first device may transmit the codeword to the second device according to the first mapping scheme and the CSI. That is, the first device may transmit the first portion of the codeword via the strongest layer indicated in the CSI during a first duration and a second portion of the codeword via the strongest layer and a duplicate of the first portion of the codeword via the second strongest layer indicated in the CSI during a second duration. The second device may utilize the first mapping scheme as well as the CSI to decode the codeword received from the first device. Using the techniques as described herein may improve the reliability of MIMO communications.

Aspects of the disclosure are initially described in the context of wireless communications systems. Additional aspects of the disclosure are described in the context of mapping techniques, a MIMO transmission, and a process flow. Aspects of the disclosure are further illustrated by and described with reference to apparatus diagrams, system diagrams, and flowcharts that relate to CSI feedback for different codeword to layer mapping schemes.

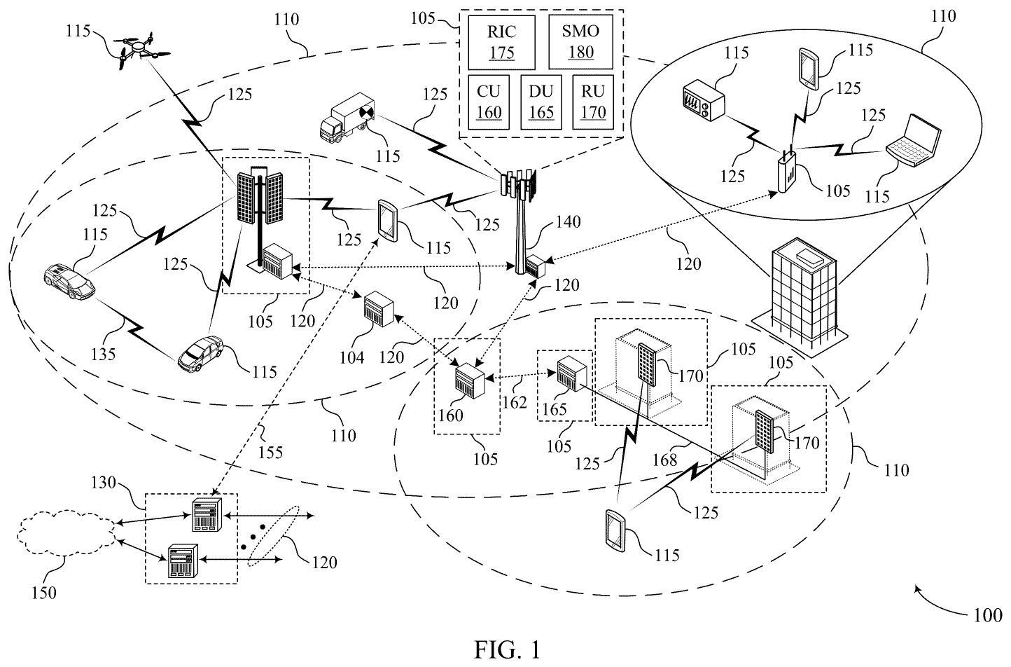

FIG. 1 shows an example of a wireless communications system 100 that supports CSI feedback for different codeword to layer mapping schemes in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, the UE 115 and the network entity 105 may gain knowledge of a relative strength of spatial layers to enhance MIMO communication. In some examples, the UE 115 may receive a configuration from the network entity 105 that indicates a codeword-to-spatial layer mapping scheme. Further, the UE 115 may receive a set of CSI-RSs from the network entity 105 and generate CSI that corresponds to the codeword-to-spatial layer mapping scheme and includes information that indicates an order of a set of spatial layers based on the relative signal strengths associated with the set of spatial layers. Additionally, the UE 115 may transmit, to the network entity 105, the CSI and in accordance with the CSI and the codeword-to-spatial layer mapping, the UE 115 may transmit, to the network entity 105, a codeword. The network entity 105 may receive the codeword from the UE 115 and decode the codeword in accordance with the codeword-to-spatial layer mapping and the CSI. Using the techniques as described herein may improve the reliability of MIMO communications when compared to other methods.

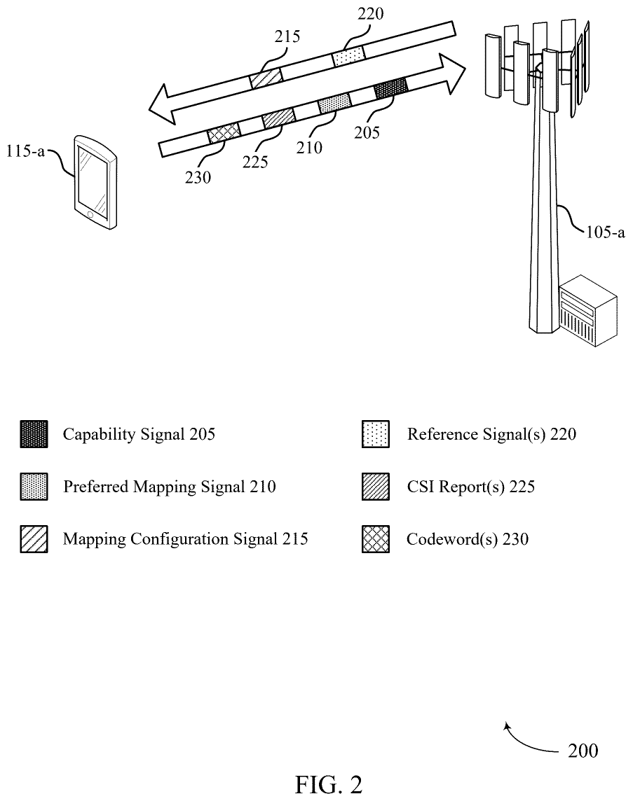

FIG. 2 shows an example of a wireless communications system 200 that supports CSI feedback for different codeword to layer mapping schemes in accordance with one or more aspects of the present disclosure. In some examples, the wireless communications system 200 may implement aspects of the wireless communications system 100. For example, the wireless communications system 200 may include a UE 115-a which may be an example of a UE 115 as described with reference to FIG. 1. Additionally, the wireless communications system 200 may include a network entity 105-a which may be an example of a network entity 105 as described with reference to FIG. 1

In some examples, devices of the wireless communications system 200 (e.g., the network entity 105-a or the UE 115-a) may support MIMO. Using MIMO, a device may transmit multiple data streams (e.g., multiple same data streams or multiple different data streams) using same time and frequency resources, but different spatial layers (e.g., different antennas). For example, a device that supports rank 2 MIMO may transmit a first data stream using a first spatial layer (or a first antenna) and a second data stream using a second spatial layer (or a second antenna). In some examples, the UE 115-a may utilize rank 2 MIMO to transmit a codeword to the network entity 105-a. In order to transmit the codeword using rank 2 MIMO, the UE 115-a may split the codeword into multiple portions (or code blocks). As an example, the UE 115-a may split the codeword into a first portion, a second portion, and a third portion. Upon splitting the codeword, the UE 115-a may map the portions of the codeword to two spatial layers (e.g., the first spatial layer and the second spatial layer).

Using a first mapping technique, transmitting the codeword may include transmitting the first portion using the first spatial layer and a copy of the first portion using the second spatial layer during a first duration. Further, transmitting the codeword may include transmitting the second portion using the first spatial layer and a copy of the second portion using the second spatial layer during a second duration. Moreover, transmitting the codeword may include transmitting the third portion using the first spatial layer and a copy of the third portion using the second spatial layer during a third duration. That is, using the first mapping technique, the UE 115-a may transmit duplicates of a portion during a same duration using different spatial layers.

Using a second mapping technique, transmitting the codeword may include transmitting the first portion using the first spatial layer during a first duration. Further, transmitting the codeword may include transmitting a second portion using the first spatial layer and a copy of the first portion using the second spatial layer during a second duration. Moreover, transmitting the codeword may include transmitting a third portion using the first spatial layer and a copy of the second portion using the second spatial layer during a third duration. That is, using the second mapping technique, the UE 115-a may transmit duplicates of portions during different durations using different spatial layers.

When the network entity 105-a receives the codeword mapped according to the second mapping technique, the network entity 105-a may perform demapping (or successive interference cancellation). During demapping, the network entity 105-a may demodulate and decode the first portion sent during the first duration. If decoding of the first portion is successful, the network entity may subtract the first portion from the signal received during the second duration to decode and demodulate the second portion. Further, if decoding of the second portion is successful, the network entity 105-a may subtract the second portion from the signal received during the third duration to decode and demodulate the third portion.

When utilizing the second mapping technique, it may be beneficial for the devices of the wireless communications system 200 to have knowledge of the relative strengths of the spatial layers such that strongest portions of the codeword (e.g., portions that are decoded after interference is canceled (e.g., the first portion transmitted during the first duration, the second portion transmitted during the second duration, and the third portion transmitted during the third duration)) are mapped to strongest spatial layers. Thus, as described herein, the UE 115-a may provide information regarding the relative strengths of the spatial layers to the network entity 105-a.

In some examples, the network entity 105-a may transmit a mapping configuration signal 215 (e.g., an RRC signal) to the UE 115-a configuring the UE 115-a with one or more mapping techniques. For example, the network entity 105-a may configure the UE 115-a with one or both of the first mapping technique or the second mapping technique. Further, in some examples, the network entity 105-a may indicate dynamic switching between the configured mapping techniques. For example, the network entity 105-amay transmit a signal (e.g., via DCI) indicating for the UE 115-a to switch from the first mapping technique to the second mapping technique or vice versa.

In some examples, prior to the network entity 105-a configuring the UE 115-a with the one or more mapping techniques, the UE 115-a may transmit a capability signal 205 to the network entity 105-a indicating one or more mapping techniques supported by the UE 115-a. Additionally or alternatively, prior to the network entity 105-a configuring the UE 115-a with the one or more mapping techniques, the UE 115-a may transmit a preferred mapping signal 210 to the network entity 105-a indicating one or more preferred mapping techniques. In some examples, the network entity 105-a may consider the information included in one or both of the capability signal 205 or the preferred mapping signal 210 when configuring the UE 115-a with the one or more mapping techniques. For example, if the capability signal 205 indicates that the UE 115-a supports the first mapping technique and not the second mapping technique, the network entity 105-a may configure the UE 115-a with the first mapping technique.

Upon configuring the UE 115-a with the one or more mapping techniques, the network entity 105-a may transmit one or more reference signals 220 (e.g., one or more CSI-RSs) to the UE 115-a. In response to receiving the one or more reference signals 220, the UE 115-a may measure the one or more reference signals 220 and generate CSI for each mapping technique configured for the UE 115-a based on the measurements. For example, if the UE 115-a is configured with both the first mapping technique and the second mapping technique, the UE 115-a may generate first CSI conditioned on the first mapping technique and generate second CSI conditioned on the second mapping schemes. In some examples, each CSI (e.g., the first CSI and the second CSI) may include one or more parameters such as a precoding matrix indicator (PMI), a channel quality indictor (CQI), a rank indicator (RI), a layer indicator (LI), or a layer order indicator (LOI). In some examples, values of the parameters may differ between CSI corresponding to different mapping techniques. For example, the first CSI may include a first CQI value that is different than a second CQI value of the second CSI.

The LI may be associated with the PMI and may indicate which column of the precoder matrix reported in the PMI corresponds to the strongest spatial layer. The UE 115-a may determine the relative strengths of the spatial layers based on the measurements of the one or more reference signals 220. In contrast to the LI, the LOI may indicate an order of the spatial layers from weakest to strongest or from strongest to weakest. In some examples, the LOI may be associated with the PMI and indicate an order of the columns of the precoder matrix reported in the PMI which corresponds to the spatial layers ordered from strongest to weakest or weakest to strongest. As one example, the UE 115-a may support rank 4 MIMO or four spatial layers (e.g., a first spatial layer, a second spatial layer, a third spatial layer, and a fourth spatial layer). In such example, the LOI may indicate that the first spatial layer is the strongest followed by the second spatial layer, the third spatial layer, and the fourth spatial layer. In some examples, if LI and LOI are separate parameters in the CSI, the LOI may indicate the order of the spatial layers other than the strongest layer indicated by the LI. Alternatively, the CSI may not include the LI because the indication of the strongest layer is indicated by the LOI. In some examples, the UE 115-a may generate LOI per wideband (e.g., one LOI for an entire band) or per subband (e.g., one LOI for every subband).

Upon generating the CSI (e.g., the first CSI and the second CSI), the UE 115-a may transmit one or more CSI reports 225 to the network entity 105-a. In one example, the UE 115-a may transmit, to the network entity 105, a first CSI report that includes the first CSI and a second report that include the second CSI. Alternatively, the UE 115-a may transmit a single CSI report 225 that indicates a difference between CSIs for different mapping techniques (e.g., a difference between the first CSI report and the second CSI report). For example, the CSI report 225 may include a difference between the first CQI of the first CSI and the second CQI of the second CSI.

Upon receiving the one or more CSI reports 225, the network entity 105-a may obtain knowledge of the order of the relative strengths of the spatial layers using, at least, the LOI included in the one or more CSI reports 225. As an example, for rank 4 MIMO, the LOI may indicate that a first spatial layer is the strongest spatial layer followed by the second spatial layer, the third spatial layer, and the fourth spatial layer. At a later time, the network entity 105-a may transmit signaling scheduling the UE 115-a to transmit a codeword 230 to the network entity 105-a. If the UE 115-a is configured to utilize the second mapping technique, the UE 115-a may transmit the codeword 230 in accordance with the second mapping technique and in accordance with the determined relative order of the spatial layers. For example, the UE 115-a may map the strongest portions of the codeword 230 to the strongest spatial layers indicated by the LOI and transmit the codeword 230. The network entity 105 may receive the codeword 230 and decode the codeword 230 using the information included in the CSI report 225 (e.g., the LOI included in the first CSI report).

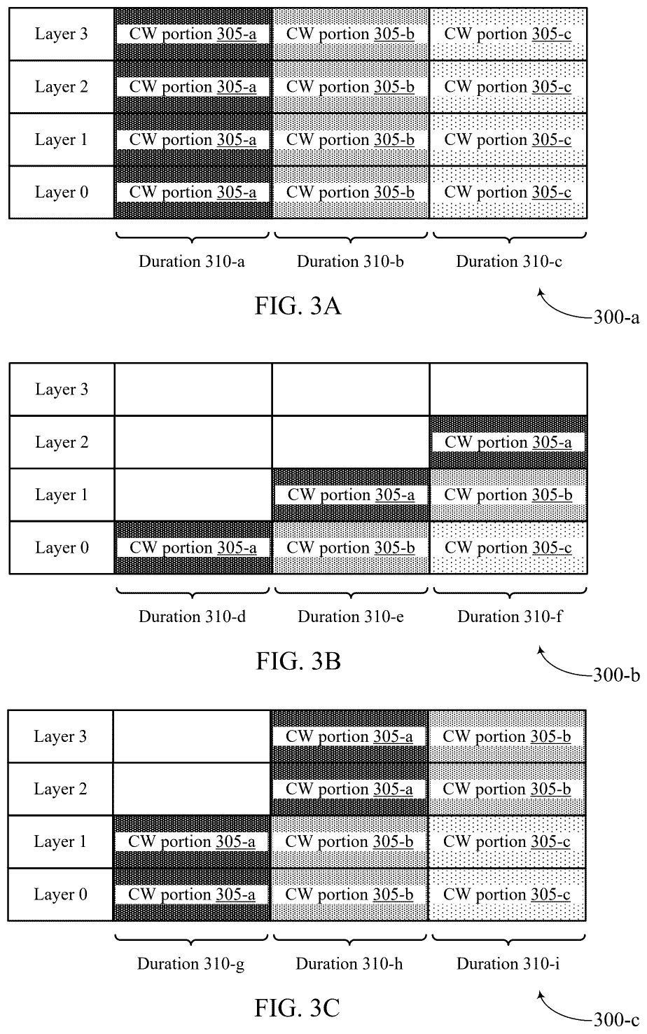

FIGS. 3A, 3B, and 3C show examples of a mapping technique 300 (e.g., a mapping technique 300-a, a mapping technique 300-b, and a mapping technique 300-c) that supports CSI feedback for different codeword to layer mapping schemes in accordance with one or more aspects of the present disclosure. In some examples, the mapping techniques 300 may be implemented by aspects of the wireless communications system 100 or the wireless communications system 200. For example, the mapping techniques 300 may be implemented by a UE 115 or a network entity 105 as described with reference to FIGS. 1 and 2.

As described in FIG. 2, a device (e.g., a UE) may be configured with one or more mapping techniques 300 (e.g., via signaling from a network entity) which the device may implement during MIMO communication. The mapping technique 300-a, the mapping technique 300-b, and the mapping technique 300-c may be examples of possible mapping techniques 300 configured to the device for MIMO communication and may indicate how the device may map a codeword to two or more spatial layers. In the example of FIG. 3A, 3B, and 3C, the device may support rank 4 MIMO or four spatial layers (e.g., a layer 0, a layer 1, a layer 2, and a layer 3). However, it may be understood that the methods as described herein may apply to any number of spatial layers (e.g., two spatial layers). In some examples, prior to mapping the codeword to the spatial layers in accordance to one of the mapping technique 300, the device may divide the codeword into two or more portions 305. For example, the device may divide the codeword into a portion 305-a, a portion 305-b, and a portion 305-c.

The mapping technique 300-a may be an example of a single CW design with irregular low density parity check (LDPC). As shown in FIG. 3A, during a duration 310-a, the device may transmit the portion 305-a using all of the spatial layers (e.g., the layer 0, the layer 1, the layer 2, and the layer 3). Further, during a duration 310-b, the device may transmit the portion 305-b using all of the spatial layers. Moreover, during a duration 310-c, the device may transmit the portion 305-c using all of the spatial layers. That is, using the mapping technique 300-a, the device may map duplicates of a portion 305 to each of the layers during a respective duration 310.

The mapping technique 300-b may be an example of a successive interference cancellation single codeword design. As shown in FIG. 3B, during a duration 310-d, the device may transmit the portion 305-a (e.g., the first occurrence of the portion 305-a) using the layer 0. Further, during a duration 310-e, the device may transmit the portion 305-b (e.g., the first occurrence of the portion 305-b) using the layer 0 and the portion 305-a (e.g., the second occurrence of the portion 305-a) using the layer 1. Moreover, during a duration 310-f, the device may transmit the portion 305-c (e.g., the first occurrence of the portion 305-c) using the layer 0, the portion 305-b (e.g., the second occurrence of the portion 305-b) using the layer 1, and the portion 305-a (e.g., the third occurrence of the portion 305-a) using the layer 2. That is, using the mapping technique 300-b, the device may map a first occurrence of portions 305 to a same spatial layer (e.g., the layer 0) and map future occurrences of portions 305 to other spatial layers (e.g., the layer 1, the layer 2, and the layer 3).

The mapping technique 300-c may be an example of a successive interference cancellation single codeword design that supports spatial layer grouping. In the example of FIG. 3C, the layers may be grouped into spatial layer groups. For example, a first spatial layer group may include the layer 0 and the layer 1 and a second spatial layer group may include the layer 2 and the layer 3. Although FIG. 3C illustrates each spatial layer group including two spatial layers, the spatial layer group may include any number of layers. As shown in FIG. 3C, during a duration 310-g, the device may transmit duplicates of the portion 305-a using the first spatial layer group. Further, during a duration 310-h, the device may transmit duplicates of the portion 305-b using the first spatial layer group and duplicates of the portion 305-a using the second spatial layer group. Moreover, during a duration 310-i, the device may transmit duplicates of the portion 305-c using the first spatial layer group and the duplicates of the portion 305-b using the second spatial layer group. That is, using the mapping technique 300-c, the device may map first occurrences of duplicates of portions 305 to a same spatial group (e.g., the first spatial layer group) and future occurrences of the duplicates of the portions 305 to other spatial groups (e.g., the second spatial layer group).

As described with reference to FIG. 2, prior to implementing one of the mapping techniques 300 for MIMO communication, the device may perform CSI reporting. That is, the device may receive one or more reference signals from the network entity and generate CSI for each of the one or more configured mapping techniques 300 based on measurements of the one or more reference signals. For example, the device may generate one or more of first CSI for the mapping technique 300-a, second CSI for the mapping technique 300-b, and third CSI for the mapping technique 300-c. In some examples, one or more of the first CSI, the second CSI, or the third CSI may include an LOI. The LOI may indicate an order of spatial layers or spatial layer groups from strongest to weakest (e.g., in terms of received signal strength).

For example, the LOI of the second CSI may indicate that the layer 0 is the strongest spatial layer followed by the layer 1, the layer 2, and the layer 3. Using this information, the device may map the first occurrence of the portion 305 (e.g., the strong portion) to the strongest layer and future occurrences of the portion 305 (e.g., the interference portion) to less strong layers. For example, as shown in FIG. 3B, the device may map the first occurrence of the portion 305-a to the layer 0 (e.g., the strongest layer), the second occurrence of the portion 305-a to the layer 1 (e.g., the second strongest layer), and the third occurrence of the portion 305-a to the layer 2 (e.g., the third strongest layer).

As another example, the LOI of the third CSI may indicate that the first spatial layer group (e.g., the layer 0 and the layer 1) is stronger than the second spatial layer group (e.g., the layer 2 and the layer 2). Using this information, the device may map first occurrences of duplicate portions 305 (e.g., the strong portions) to the strongest spatial layer group and future occurrences of the duplicates of the portions 305 (e.g., the interference portions) to less strong spatial layer groups. For example, as shown in FIG. 3C, the device may map the first occurrence of the duplicates of the portion 305-a to the first spatial layer group (e.g., the strongest spatial layer group) and the second occurrence of the duplicates of the portion 305-a to the second spatial layer group (e.g., the second strongest spatial layer group).

Further, the device may transmit the one or more CSIs (e.g., the first CSI, the second CSI, or the third CSI) to the network entity via separate CSI reports or a singular CSI report. The network entity may utilize the one or more CSIs, or more specifically the LOI included in the one or more CSIs, to demodulate and decode the codeword received from the device. For example, if the device utilizes the mapping technique 300-b for MIMO communications, the network entity may determine to decode the portion 305-b received during the duration 310-e after interference is canceled and to decode the portion 305-b received during the duration 310-e by interference as noise based on the LOI included in the second CSI.

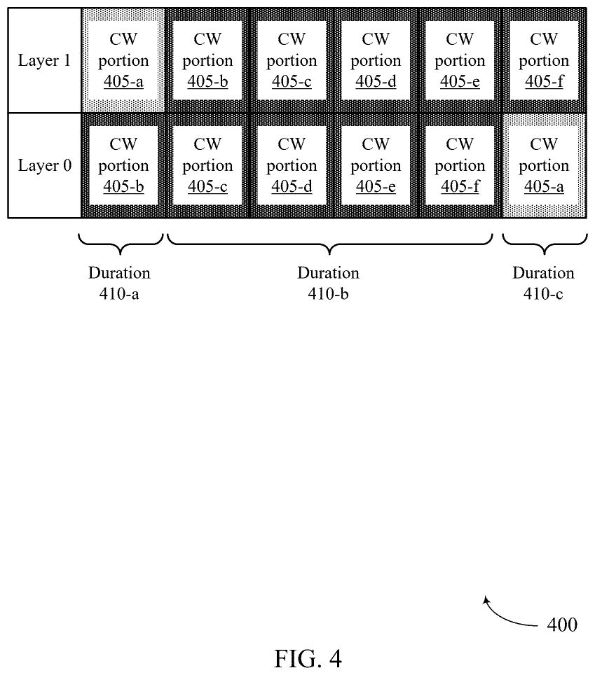

FIG. 4 shows an example of a MIMO transmission 400 that supports CSI feedback for different codeword to layer mapping schemes in accordance with one or more aspects of the present disclosure. In some examples, the MIMO transmission 400 may be implemented by aspects of the wireless communications system 100 or the wireless communications system 200. For example, the MIMO transmission 400 may be implemented by a UE 115 or a network entity 105 as described with reference to FIGS. 1 and 2.

As described with reference to FIG. 2, a device (e.g., a UE) may generate CSI for each configured one or more mapping techniques. For example, as described in FIGS. 3A and 3B, the device may generate first CSI for the mapping technique 300-a and second CSI for the mapping technique 300-b. Further, the device may transmit the first CSI and the second CSI to a network entity via one or more CSI reports. For example, the device may transmit first CSI report including the first CSI and a second CSI report including the second CSI to the network entity. In some examples, the first CSI may include an LOI that indicates an order of layers in terms of strength. For example, if the device supports and implements rank 2 MIMO, the LOI may indicate that a layer 0 is stronger than a layer 1.

In the example of FIG. 4, the device may implement a successive interference single codeword design (e.g., the mapping technique 300-a) to map a codeword to two spatial layers (e.g., the layer 0 and the layer 1). In some examples, prior to mapping the codeword, the device may divide the codeword into multiple portions. For examples, the device may divide the codeword into a portion 405-a, a portion 405-b, a portion 405-c, a portion 405-d, a portion 405-e, and a portion 405-f.

As described in FIG. 3B, the device may not transmit a portion of a codeword using one or more of the layers leaving the one or more layers unused. For example, as shown in FIG. 3B, the device may not transmit a portion of the codeword using the layer 1, the layer 2, and the layer 3 during the duration 310-d. FIG. 4 illustrates an example in which the device utilizes an unused layer to transmit an easily decodable portion of the codeword (e.g., the portion 405-a). That is, the device may transmit the portion 405-a using a second MCS that is less than a first MCS used to transmit other portions of the codeword (e.g., the portions 405-b through 405-f). In some examples, the network entity may determine the second MCS using the second CSI (e.g., the CSI associated with the mapping technique 300-b) and schedule the device to transmit the portion 405-a using the second MCS. Additionally, the network entity may determine the first MCS using the first CSI and schedule the device to transmit the other portions using the first MCS.

For example, during the duration 410-a or head portion of the codeword transmission, the device may transmit the portion 405-b using the layer 0 according to the first MCS and the portion 405-a using the layer 1 according to the second MCS. Further, during the duration 410-b, the device may transmit the portions 405-b through 405-f using the successive interference single codeword design and according to the second MCS. Moreover, during the duration 410-c or a tail portion of the codeword transmission, the device may transmit the portion 405-f using the layer 1 according to the first MCS and the portion 405-a using the layer 0 according to the second MCS. The network entity may receive the codeword and perform successive decoding of the codewords from either the head or the tail.

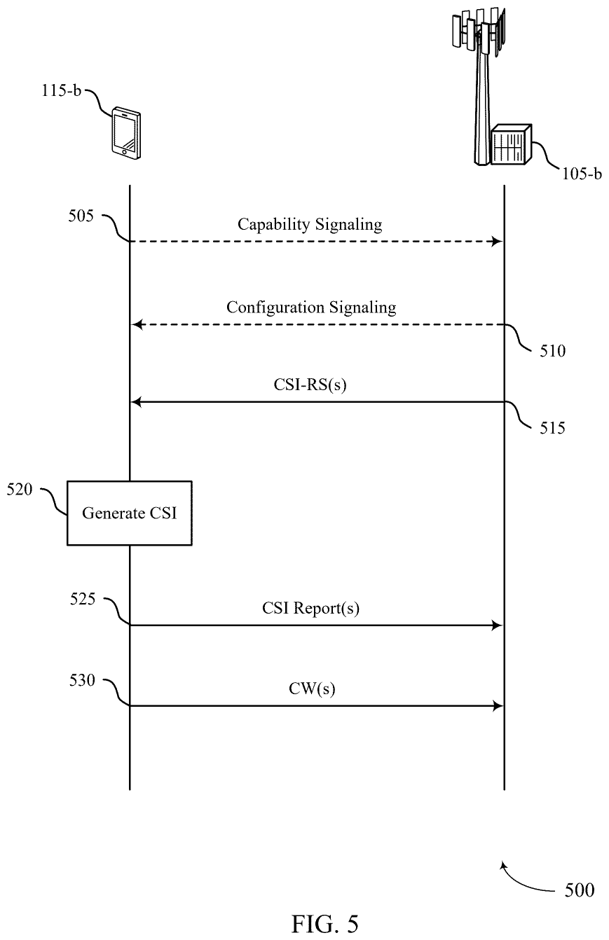

FIG. 5 shows an example of a process flow 500 that supports CSI feedback for different codeword to layer mapping schemes in accordance with one or more aspects of the present disclosure. In some examples, the process flow 500 may implement, or be implemented by, aspects of the wireless communications system 100 or the wireless communications system 200. For example, the process flow 500 may be implemented by a UE 115-b and a network entity 105-b which may examples of a UE 115 and a network entity 105, respectively, as described with reference to FIGS. 1 and 2. Alternative examples of the following may be implemented, where some steps are performed in a different order then described or are not performed at all. In some cases, steps map include additional features not mentioned below, or further steps may be added. Additionally or alternatively, the UE 115-b may select a codeword-to-spatial layer mapping from a set of codeword-to-spatial layers mappings and transmit, to the network entity 105-b, preferred mapping signaling indicating the selected codeword-to-layer mapping.

At 505, the UE 115-b may transmit, to the network entity 105-b, capability signaling indicating capability information that indicates a supported codeword-to-spatial layer mapping scheme.

At 510, the UE 115-b may receive, from the network entity 105-b, configuration signaling that includes a configuration that indicates a codeword-to-spatial layer mapping. In some examples, the codeword-to-spatial layer mapping indicated by the configuration may be equal to the codeword-to-spatial layer mapping indicated by the UE 115-b via the capability signaling or the codeword-to-spatial mapping indicated by the UE 115-b via the preferred mapping signaling.

At 515, the UE 115-b may receive, from the network entity 105-b, a set of CSI-RSs.

At 520, the UE 115-b may generate CSI associated with the CSI-RSs based on the configured codeword-to-spatial layer mapping. In some examples, the CSI may include an LOI or information that indicates an order of a set of spatial layers that is based on relative signal strengths associated with the set of spatial layers.

A first LOI may indicate that a first spatial layer of the set of spatial layers associated with a signal strength that is greater than a signal strength associated with a second spatial layer of the set of spatial layers.

A second LOI may indicate that that a first spatial layer group (e.g., the first spatial layer of the set of spatial layers and the second spatial layer) is associated with a stronger signal strength compared to a signal strength associated with a second spatial layer group (e.g., a third spatial layer of the set of spatial layers and a fourth spatial layer of the set of spatial layers).

At 525, the UE 115-b may transmit the CSI to the network entity 105-b. In some examples, the CSI may include one or more both of the first LOI or the second LOI.

At 530, the UE 115-b may transmit a set of codewords to the network entity 105-b in accordance to the configured codeword-to-layer mapping and the LOI included in the CSI. For example, in accordance to the configured codeword-to-layer mapping and the first LOI, the UE 115-b may transmit, during a first duration, a first portion of a codeword of the set of codewords using the first spatial layer and transmit, during a second duration, the first portion of the codewords using the second spatial layer and a second portion of the codeword using the first spatial layer. As another example, in accordance with the configured codeword-to-layer mapping and the second LOI, the UE 115-b may transmit, during a first duration, the first portion of the codeword using the first spatial layer group and transmit, during a second duration, the first portion of the codewords using the second spatial layer group and the second portions of the codeword using the first spatial layer group.

In some examples, the UE 115-b may be configured with a second codeword-to-spatial layer mapping. In such example, the UE 115-b may generate second CSI based on the second codeword-to-spatial layer mapping. Further, the UE 115-b may transmit, to the network entity 105-b, the second CSI. In some examples, the UE 115-b may map the codeword to the set of spatial layers based on both the CSI and the second CSI.

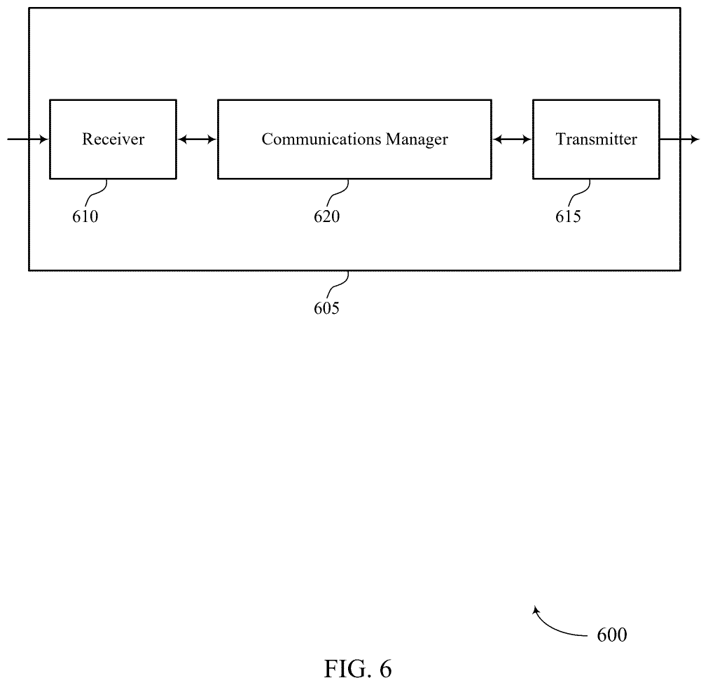

FIG. 6 shows a block diagram 600 of a device 605 that supports CSI feedback for different codeword to layer mapping schemes in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to CSI feedback for different codeword to layer mapping schemes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CSI feedback for different codeword to layer mapping schemes). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of CSI feedback for different codeword to layer mapping schemes as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a set of CSI-RSs. The communications manager 620 is capable of, configured to, or operable to support a means for transmitting CSI based on the received set of CSI-RSs, the CSI including information that indicates an order of a set of spatial layers, where the order is based on relative signal strengths associated with the set of spatial layers. The communications manager 620 is capable of, configured to, or operable to support a means for transmitting a set of codewords based on a mapping between each codeword of the set of codewords and each spatial layer of the set of spatial layers.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

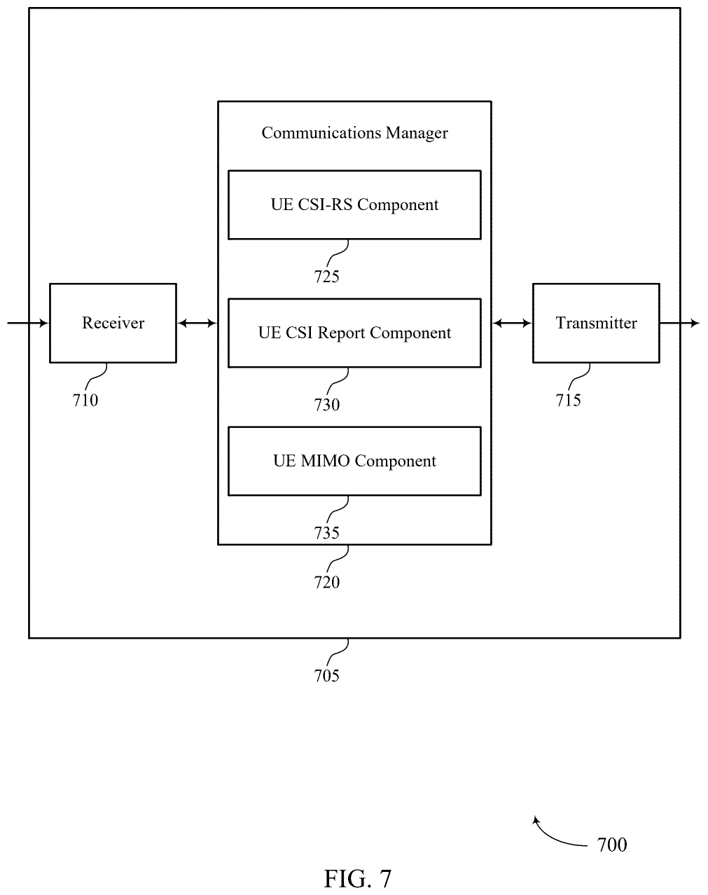

FIG. 7 shows a block diagram 700 of a device 705 that supports CSI feedback for different codeword to layer mapping schemes in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to CSI feedback for different codeword to layer mapping schemes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CSI feedback for different codeword to layer mapping schemes). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of CSI feedback for different codeword to layer mapping schemes as described herein. For example, the communications manager 720 may include a UE CSI-RS component 725, a UE CSI report component 730, a UE MIMO component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The UE CSI-RS component 725 is capable of, configured to, or operable to support a means for receiving a set of CSI-RSs. The UE CSI report component 730 is capable of, configured to, or operable to support a means for transmitting CSI based on the received set of CSI-RSs, the CSI including information that indicates an order of a set of spatial layers, where the order is based on relative signal strengths associated with the set of spatial layers. The UE MIMO component 735 is capable of, configured to, or operable to support a means for transmitting a set of codewords based on a mapping between each codeword of the set of codewords and each spatial layer of the set of spatial layers.

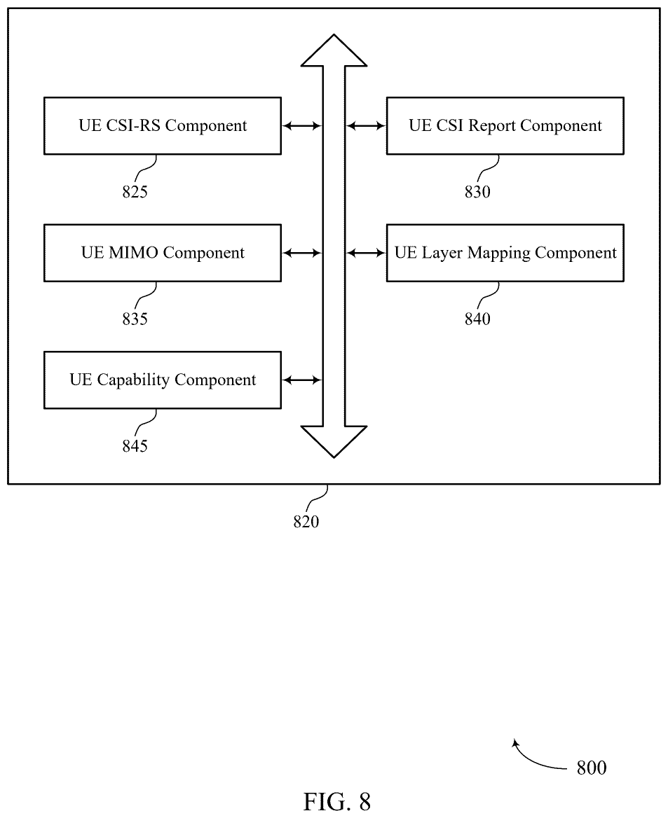

FIG. 8 shows a block diagram 800 of a communications manager 820 that supports CSI feedback for different codeword to layer mapping schemes in accordance with one or more aspects of the present disclosure. The communications manager 820 may be an example of aspects of a communications manager 620, a communications manager 720, or both, as described herein. The communications manager 820, or various components thereof, may be an example of means for performing various aspects of CSI feedback for different codeword to layer mapping schemes as described herein. For example, the communications manager 820 may include a UE CSI-RS component 825, a UE CSI report component 830, a UE MIMO component 835, a UE layer mapping component 840, a UE capability component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The UE CSI-RS component 825 is capable of, configured to, or operable to support a means for receiving a set of CSI-RSs. The UE CSI report component 830 is capable of, configured to, or operable to support a means for transmitting CSI based on the received set of CSI-RSs, the CSI including information that indicates an order of a set of spatial layers, where the order is based on relative signal strengths associated with the set of spatial layers. The UE MIMO component 835 is capable of, configured to, or operable to support a means for transmitting a set of codewords based on a mapping between each codeword of the set of codewords and each spatial layer of the set of spatial layers.

In some examples, the UE layer mapping component 840 is capable of, configured to, or operable to support a means for receiving a configuration that indicates a codeword-to-spatial layer mapping, where the mapping between each codeword of the set of codewords and each spatial layer of the set of spatial layers is based on the received configuration.

In some examples, the UE layer mapping component 840 is capable of, configured to, or operable to support a means for selecting a codeword-to-spatial layer mapping scheme from a set of multiple mapping schemes, where the mapping between each codeword of the set of codewords and each spatial layer of the set of spatial layers is based on the selected codeword-to-spatial layer mapping scheme. In some examples, the UE layer mapping component 840 is capable of, configured to, or operable to support a means for transmitting an indication of the selected codeword-to-spatial layer mapping scheme.

In some examples, the UE capability component 845 is capable of, configured to, or operable to support a means for transmitting capability information that indicates a supported codeword-to-spatial layer mapping scheme, where the mapping between each codeword of the set of codewords and each spatial layer of the set of spatial layers is based on the transmitted capability information.

In some examples, the UE layer mapping component 840 is capable of, configured to, or operable to support a means for receiving an indication to switch from a first codeword-to-spatial layer mapping scheme to a second codeword-to-spatial layer mapping scheme, where the mapping between each codeword of the set of codewords and each spatial layer of the set of spatial layers is based on the received indication.

In some examples, the order indicates that a first spatial layer of the set of spatial layers is associated with a signal strength that is greater than a signal strength associated with a second spatial layer of the set of spatial layers.

In some examples, the order further indicates that a third spatial layer of the set of spatial layers is associated with a signal strength that is less than the signal strength associated with the first spatial layer and greater than the signal strength associated with the second spatial layer.

In some examples, to support transmitting the set of codewords, the UE MIMO component 835 is capable of, configured to, or operable to support a means for transmitting, during a first duration, a first portion of a codeword of the set of codewords using the first spatial layer. In some examples, to support transmitting the set of codewords, the UE MIMO component 835 is capable of, configured to, or operable to support a means for transmitting, during a second duration, the first portion of the codeword using the second spatial layer and a second portion of the codeword using the first spatial layer.

In some examples, the order indicates that a first spatial layer and a second spatial layer of the set of spatial layers are associated with a stronger signal strength compared to a signal strength of a third spatial layer and a fourth spatial layer of the set of spatial layers.

In some examples, to support transmitting the set of codewords, the UE MIMO component 835 is capable of, configured to, or operable to support a means for transmitting, during a first duration, a first portion of a codeword of the set of codewords using the first spatial layer and the second spatial layer. In some examples, to support transmitting the set of codewords, the UE MIMO component 835 is capable of, configured to, or operable to support a means for transmitting, during a second duration, the first portion of the codeword using the third spatial layer and the fourth spatial layer and a second portion of the codeword using the first spatial layer and the second spatial layer.

In some examples, the UE layer mapping component 840 is capable of, configured to, or operable to support a means for identifying a first codeword-to-spatial layer mapping scheme, where the CSI is based on the identified first codeword-to-spatial layer mapping scheme. In some examples, the UE layer mapping component 840 is capable of, configured to, or operable to support a means for identifying a second codeword-to-spatial layer mapping scheme different from the first codeword-to-spatial layer mapping scheme. In some examples, the UE CSI report component 830 is capable of, configured to, or operable to support a means for generating second CSI, where the second CSI is based on the identified second codeword-to-spatial layer mapping scheme.

In some examples, the UE CSI report component 830 is capable of, configured to, or operable to support a means for transmitting the second CSI. In some examples, the UE CSI report component 830 is capable of, configured to, or operable to support a means for transmitting signaling indicative of a difference between the CSI and the second CSI. In some examples, one or more parameters included in the CSI are equal to one or more parameters included in the second CSI. In some examples, the mapping between each codeword of the set of codewords and each spatial layer of the set of spatial layers is based on the CSI and the second CSI.

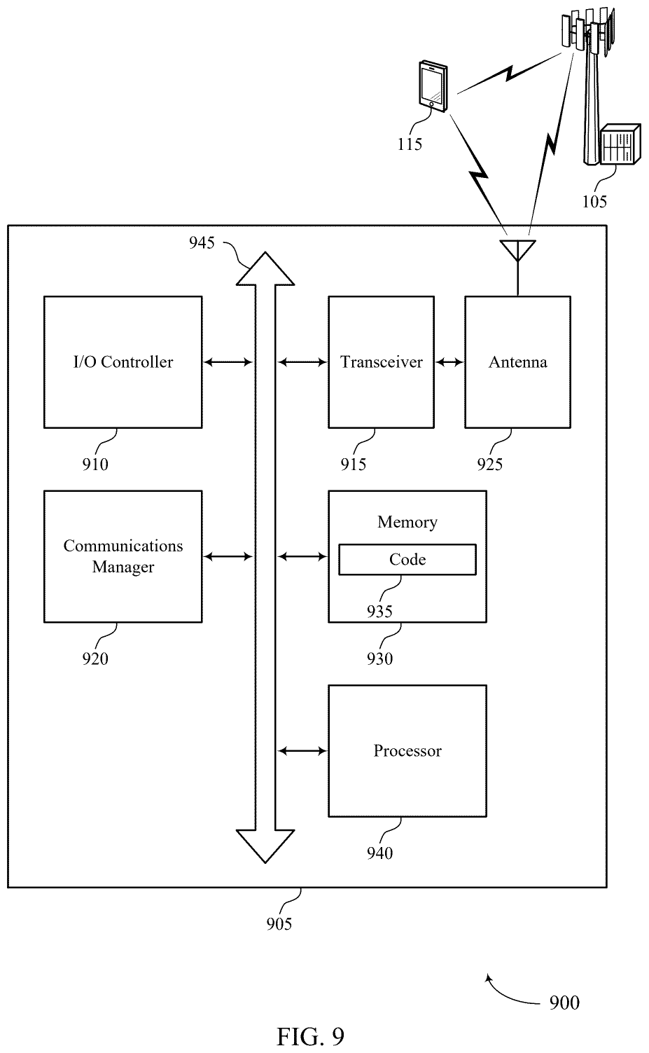

FIG. 9 shows a diagram of a system 900 including a device 905 that supports CSI feedback for different codeword to layer mapping schemes in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting CSI feedback for different codeword to layer mapping schemes). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a set of CSI-RSs. The communications manager 920 is capable of, configured to, or operable to support a means for transmitting CSI based on the received set of CSI-RSs, the CSI including information that indicates an order of a set of spatial layers, where the order is based on relative signal strengths associated with the set of spatial layers. The communications manager 920 is capable of, configured to, or operable to support a means for transmitting a set of codewords based on a mapping between each codeword of the set of codewords and each spatial layer of the set of spatial layers.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of CSI feedback for different codeword to layer mapping schemes as described herein, or the at least one processor 940 and the at least one memory 930 may be otherwise configured to, individually or collectively, perform or support such operations.

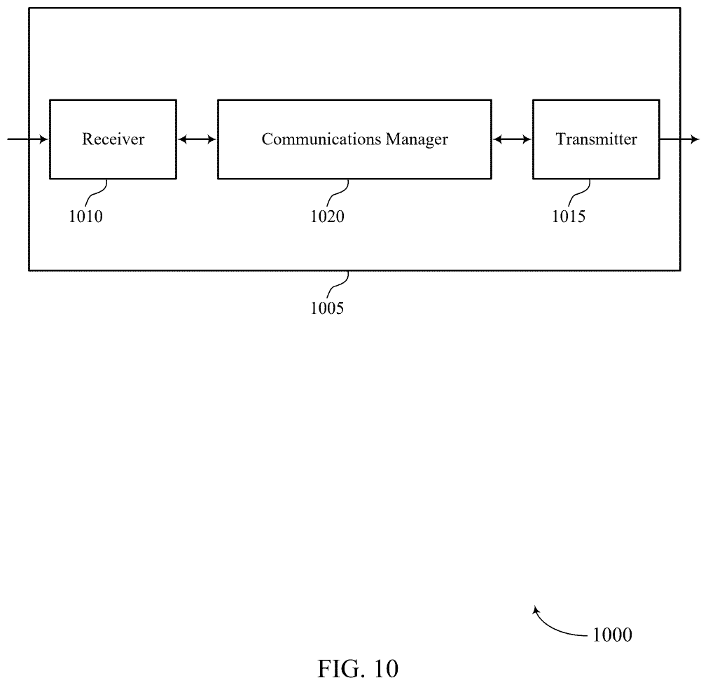

FIG. 10 shows a block diagram 1000 of a device 1005 that supports CSI feedback for different codeword to layer mapping schemes in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of CSI feedback for different codeword to layer mapping schemes as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting a set of CSI-RSs. The communications manager 1020 is capable of, configured to, or operable to support a means for receiving CSI based on transmitting the set of CSI-RSs, the CSI including information that indicates an order of a set of spatial layers, where the order is based on relative signal strengths of the set of spatial layers. The communications manager 1020 is capable of, configured to, or operable to support a means for receiving a set of codewords based on a mapping between each codeword of the set of codewords and each spatial layer of the set of spatial layers.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

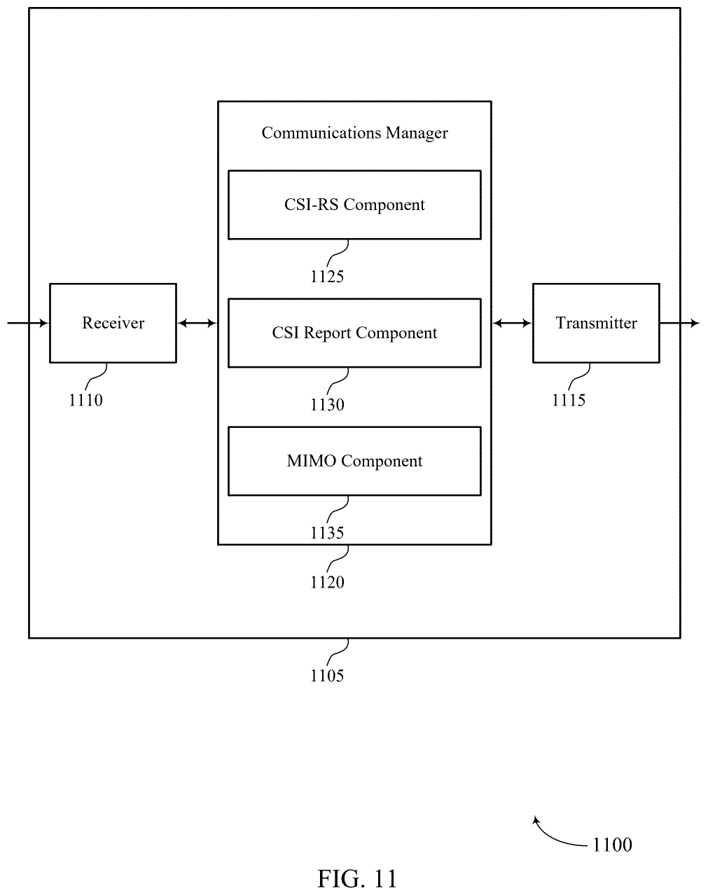

FIG. 11 shows a block diagram 1100 of a device 1105 that supports CSI feedback for different codeword to layer mapping schemes in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of CSI feedback for different codeword to layer mapping schemes as described herein. For example, the communications manager 1120 may include a CSI-RS component 1125, a CSI report component 1130, a MIMO component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The CSI-RS component 1125 is capable of, configured to, or operable to support a means for transmitting a set of CSI-RSs. The CSI report component 1130 is capable of, configured to, or operable to support a means for receiving CSI based on transmitting the set of CSI-RSs, the CSI including information that indicates an order of a set of spatial layers, where the order is based on relative signal strengths of the set of spatial layers. The MIMO component 1135 is capable of, configured to, or operable to support a means for receiving a set of codewords based on a mapping between each codeword of the set of codewords and each spatial layer of the set of spatial layers.

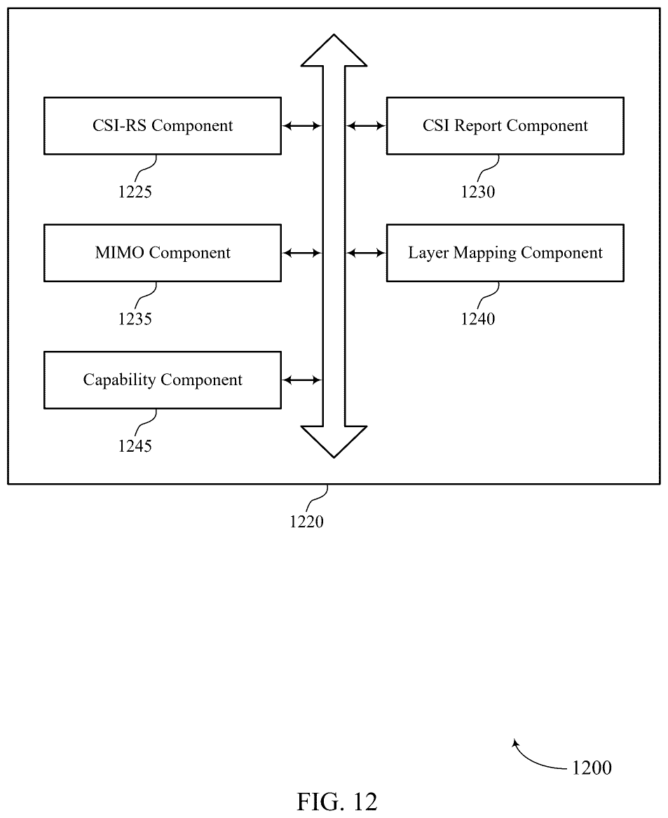

FIG. 12 shows a block diagram 1200 of a communications manager 1220 that supports CSI feedback for different codeword to layer mapping schemes in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of CSI feedback for different codeword to layer mapping schemes as described herein. For example, the communications manager 1220 may include a CSI-RS component 1225, a CSI report component 1230, a MIMO component 1235, a layer mapping component 1240, a capability component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The CSI-RS component 1225 is capable of, configured to, or operable to support a means for transmitting a set of CSI-RSs. The CSI report component 1230 is capable of, configured to, or operable to support a means for receiving CSI based on transmitting the set of CSI-RSs, the CSI including information that indicates an order of a set of spatial layers, where the order is based on relative signal strengths of the set of spatial layers. The MIMO component 1235 is capable of, configured to, or operable to support a means for receiving a set of codewords based on a mapping between each codeword of the set of codewords and each spatial layer of the set of spatial layers.

In some examples, the layer mapping component 1240 is capable of, configured to, or operable to support a means for transmitting a configuration that indicates a codeword-to-spatial layer mapping scheme, where the mapping between each codeword of the set of codewords and each spatial layer of the set of spatial layers is based on the transmitted configuration.

In some examples, the layer mapping component 1240 is capable of, configured to, or operable to support a means for receiving an indication of a codeword-to-spatial layer mapping scheme preferred by a UE, where the mapping between each codeword of the set of codewords and each spatial layer of the set of spatial layers is based on the received indication.

In some examples, the capability component 1245 is capable of, configured to, or operable to support a means for receiving capability information that indicates a supported codeword-to-spatial layer mapping scheme, where the mapping between each codeword of the set of codewords and each spatial layer of the set of spatial layers is based on the received capability information.

In some examples, the layer mapping component 1240 is capable of, configured to, or operable to support a means for transmitting an indication to switch from a first codeword-to-spatial layer mapping scheme to a second codeword-to-spatial layer mapping scheme, where the mapping between each codeword of the set of codewords and each spatial layer of the set of spatial layers is based on the transmitted indication.

In some examples, the order indicates that a first spatial layer of the set of spatial layers is associated with a signal strength that is greater than a signal strength associated with a second spatial layer of the set of spatial layers.

In some examples, the order further indicates that a third spatial layer of the set of spatial layers is associated with a signal strength that is less than the signal strength associated with the first spatial layer and greater than the signal strength associated with the second spatial layer.

In some examples, the MIMO component 1235 is capable of, configured to, or operable to support a means for receiving, during a first duration, a first portion of a codeword of the set of codewords. In some examples, the MIMO component 1235 is capable of, configured to, or operable to support a means for receiving, during a second duration, a second portion of the codeword based on the received first portion of the codeword.

In some examples, the order indicates that a first spatial layer and a second spatial layer of the set of spatial layers are associated with a stronger signal strength compared to a signal strength of a third spatial layer and a fourth spatial layer of the set of spatial layers.

In some examples, the CSI corresponds to a first codeword-to-spatial layer mapping scheme, and the CSI report component 1230 is capable of, configured to, or operable to support a means for receiving second CSI, where the second CSI corresponds to a second codeword-to-spatial layer mapping scheme. In some examples, one or more parameters included in the CSI are equal to one or more parameters included in the second CSI. In some examples, the mapping between each codeword of the set of codewords and each spatial layer of the set of spatial layers is based on the CSI and the second CSI.

In some examples, the CSI correspond to a first code-to-spatial layer mapping scheme, and the CSI report component 1230 is capable of, configured to, or operable to support a means for receiving signaling indicative of a difference between the CSI and second CSI, where the second CSI corresponds to a second codeword-to-spatial layer mapping scheme.

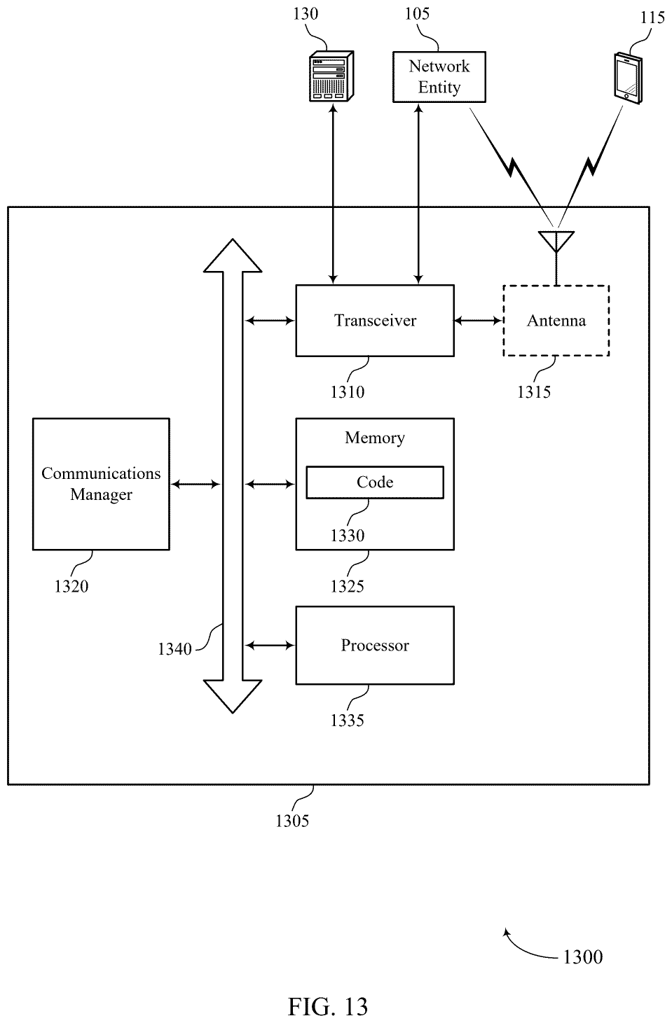

FIG. 13 shows a diagram of a system 1300 including a device 1305 that supports CSI feedback for different codeword to layer mapping schemes in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting CSI feedback for different codeword to layer mapping schemes). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting a set of CSI-RSs. The communications manager 1320 is capable of, configured to, or operable to support a means for receiving CSI based on transmitting the set of CSI-RSs, the CSI including information that indicates an order of a set of spatial layers, where the order is based on relative signal strengths of the set of spatial layers. The communications manager 1320 is capable of, configured to, or operable to support a means for receiving a set of codewords based on a mapping between each codeword of the set of codewords and each spatial layer of the set of spatial layers.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of CSI feedback for different codeword to layer mapping schemes as described herein, or the at least one processor 1335 and the at least one memory 1325 may be otherwise configured to, individually or collectively, perform or support such operations.

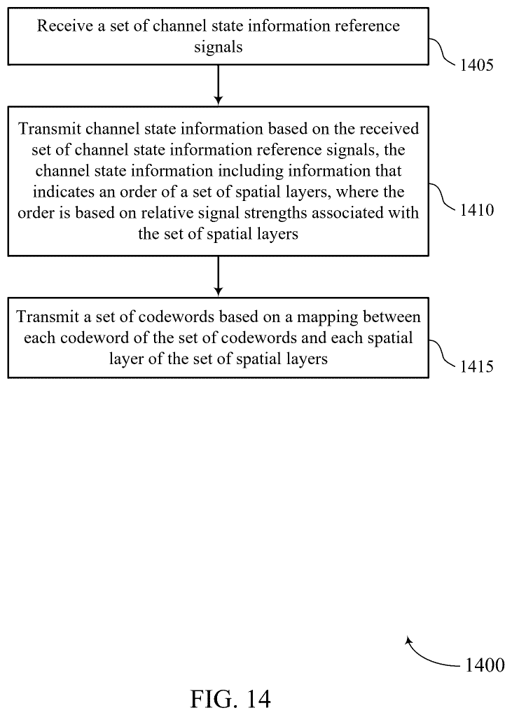

FIG. 14 shows a flowchart illustrating a method 1400 that supports CSI feedback for different codeword to layer mapping schemes in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a set of CSI-RSs. The operations of 1405 may be performed in accordance with examples as disclosed herein. In some examples, aspects of the operations of 1405 may be performed by a UE CSI-RS component 825 as described with reference to FIG. 8.

At 1410, the method may include transmitting CSI based on the received set of CSI-RSs, the CSI including information that indicates an order of a set of spatial layers, where the order is based on relative signal strengths associated with the set of spatial layers. The operations of 1410 may be performed in accordance with examples as disclosed herein. In some examples, aspects of the operations of 1410 may be performed by a UE CSI report component 830 as described with reference to FIG. 8.

At 1415, the method may include transmitting a set of codewords based on a mapping between each codeword of the set of codewords and each spatial layer of the set of spatial layers. The operations of 1415 may be performed in accordance with examples as disclosed herein. In some examples, aspects of the operations of 1415 may be performed by a UE MIMO component 835 as described with reference to FIG. 8.

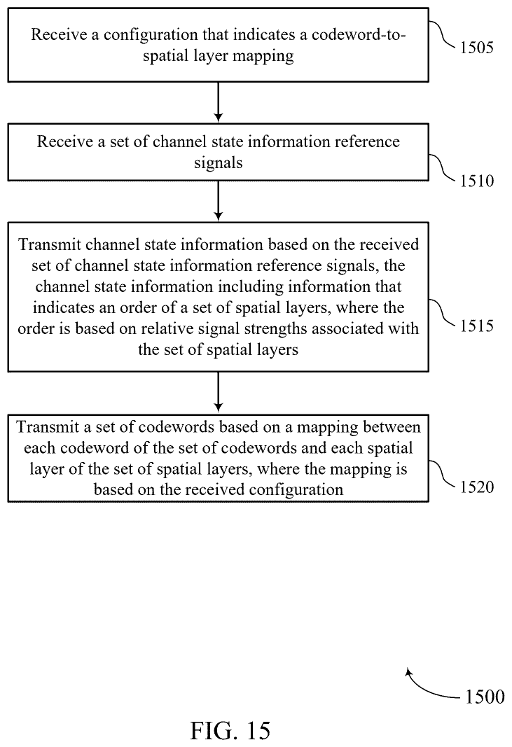

FIG. 15 shows a flowchart illustrating a method 1500 that supports CSI feedback for different codeword to layer mapping schemes in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a configuration that indicates a codeword-to-spatial layer mapping. The operations of 1505 may be performed in accordance with examples as disclosed herein. In some examples, aspects of the operations of 1505 may be performed by a UE layer mapping component 840 as described with reference to FIG. 8.

At 1510, the method may include receiving a set of CSI-RSs. The operations of 1510 may be performed in accordance with examples as disclosed herein. In some examples, aspects of the operations of 1510 may be performed by a UE CSI-RS component 825 as described with reference to FIG. 8.

At 1515, the method may include transmitting CSI based on the received set of CSI-RSs, the CSI including information that indicates an order of a set of spatial layers, where the order is based on relative signal strengths associated with the set of spatial layers. The operations of 1515 may be performed in accordance with examples as disclosed herein. In some examples, aspects of the operations of 1515 may be performed by a UE CSI report component 830 as described with reference to FIG. 8.

At 1520, the method may include transmitting a set of codewords based on a mapping between each codeword of the set of codewords and each spatial layer of the set of spatial layers, where the mapping is based on the received configuration. The operations of 1520 may be performed in accordance with examples as disclosed herein. In some examples, aspects of the operations of 1520 may be performed by a UE MIMO component 835 as described with reference to FIG. 8.

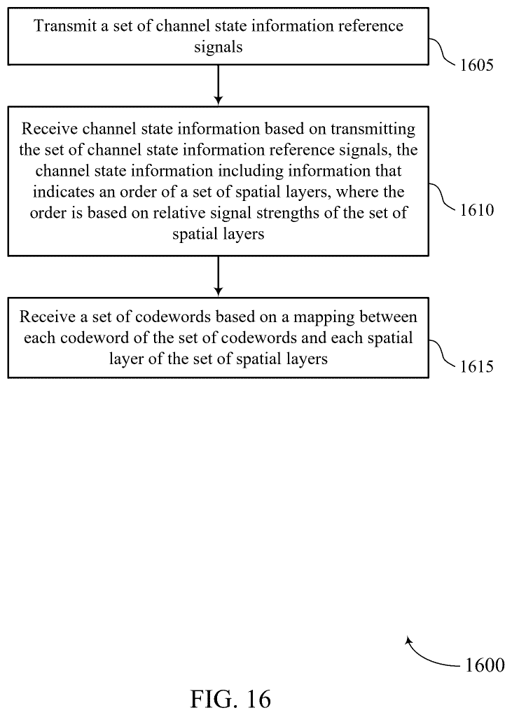

FIG. 16 shows a flowchart illustrating a method 1600 that supports CSI feedback for different codeword to layer mapping schemes in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a set of CSI-RSs. The operations of 1605 may be performed in accordance with examples as disclosed herein. In some examples, aspects of the operations of 1605 may be performed by a CSI-RS component 1225 as described with reference to FIG. 12.

At 1610, the method may include receiving CSI based on transmitting the set of CSI-RSs, the CSI including information that indicates an order of a set of spatial layers, where the order is based on relative signal strengths of the set of spatial layers. The operations of 1610 may be performed in accordance with examples as disclosed herein. In some examples, aspects of the operations of 1610 may be performed by a CSI report component 1230 as described with reference to FIG. 12.

At 1615, the method may include receiving a set of codewords based on a mapping between each codeword of the set of codewords and each spatial layer of the set of spatial layers. The operations of 1615 may be performed in accordance with examples as disclosed herein. In some examples, aspects of the operations of 1615 may be performed by a MIMO component 1235 as described with reference to FIG. 12.

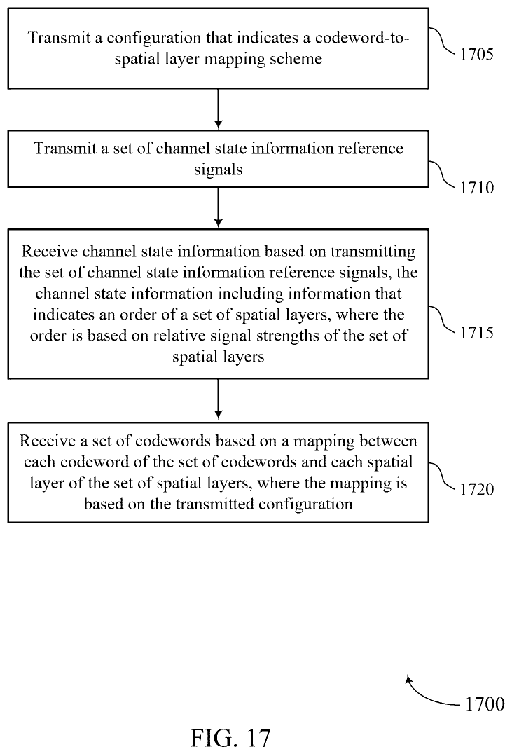

FIG. 17 shows a flowchart illustrating a method 1700 that supports CSI feedback for different codeword to layer mapping schemes in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a configuration that indicates a codeword-to-spatial layer mapping scheme. The operations of 1705 may be performed in accordance with examples as disclosed herein. In some examples, aspects of the operations of 1705 may be performed by a layer mapping component 1240 as described with reference to FIG. 12.

At 1710, the method may include transmitting a set of CSI-RSs. The operations of 1710 may be performed in accordance with examples as disclosed herein. In some examples, aspects of the operations of 1710 may be performed by a CSI-RS component 1225 as described with reference to FIG. 12.

At 1715, the method may include receiving CSI based on transmitting the set of CSI-RSs, the CSI including information that indicates an order of a set of spatial layers, where the order is based on relative signal strengths of the set of spatial layers. The operations of 1715 may be performed in accordance with examples as disclosed herein. In some examples, aspects of the operations of 1715 may be performed by a CSI report component 1230 as described with reference to FIG. 12.

At 1720, the method may include receiving a set of codewords based on a mapping between each codeword of the set of codewords and each spatial layer of the set of spatial layers, where the mapping is based on the transmitted configuration. The operations of 1720 may be performed in accordance with examples as disclosed herein. In some examples, aspects of the operations of 1720 may be performed by a MIMO component 1235 as described with reference to FIG. 12.

The following provides an overview of aspects of the present disclosure:
Aspect 1: A method for wireless communications at a UE, comprising: receiving a set of CSI-RSs; transmitting CSI based at least in part on the received set of CSI-RSs, the CSI comprising information that indicates an order of a set of spatial layers, wherein the order is based at least in part on relative signal strengths associated with the set of spatial layers; and transmitting a set of codewords based at least in part on a mapping between each codeword of the set of codewords and each spatial layer of the set of spatial layers.
Aspect 2: The method of aspect 1, further comprising: receiving a configuration that indicates a codeword-to-spatial layer mapping, wherein the mapping between each codeword of the set of codewords and each spatial layer of the set of spatial layers is based at least in part on the received configuration.
Aspect 3: The method of any of aspects 1 through 2, further comprising: selecting a codeword-to-spatial layer mapping scheme from a plurality of mapping schemes, wherein the mapping between each codeword of the set of codewords and each spatial layer of the set of spatial layers is based at least in part on the selected codeword-to-spatial layer mapping scheme; and transmitting an indication of the selected codeword-to-spatial layer mapping scheme.
Aspect 4: The method of any of aspects 1 through 3, further comprising: transmitting capability information that indicates a supported codeword-to-spatial layer mapping scheme, wherein the mapping between each codeword of the set of codewords and each spatial layer of the set of spatial layers is based at least in part on the transmitted capability information.
Aspect 5: The method of any of aspects 1 through 4, further comprising: receiving an indication to switch from a first codeword-to-spatial layer mapping scheme to a second codeword-to-spatial layer mapping scheme, wherein the mapping between each codeword of the set of codewords and each spatial layer of the set of spatial layers is based at least in part on the received indication.
Aspect 6: The method of any of aspects 1 through 5, wherein the order indicates that a first spatial layer of the set of spatial layers is associated with a signal strength that is greater than a signal strength associated with a second spatial layer of the set of spatial layers.
Aspect 7: The method of aspect 6, wherein the order further indicates that a third spatial layer of the set of spatial layers is associated with a signal strength that is less than the signal strength associated with the first spatial layer and greater than the signal strength associated with the second spatial layer.
Aspect 8: The method of any of aspects 6 through 7, wherein transmitting the set of codewords comprises: transmitting, during a first duration, a first portion of a codeword of the set of codewords using the first spatial layer; and transmitting, during a second duration, the first portion of the codeword using the second spatial layer and a second portion of the codeword using the first spatial layer.
Aspect 9: The method of any of aspects 1 through 8, wherein the order indicates that a first spatial layer and a second spatial layer of the set of spatial layers are associated with a stronger signal strength compared to a signal strength of a third spatial layer and a fourth spatial layer of the set of spatial layers.
Aspect 10: The method of aspect 9, wherein transmitting the set of codewords comprises: transmitting, during a first duration, a first portion of a codeword of the set of codewords using the first spatial layer and the second spatial layer; and transmitting, during a second duration, the first portion of the codeword using the third spatial layer and the fourth spatial layer and a second portion of the codeword using the first spatial layer and the second spatial layer.
Aspect 11: The method of any of aspects 1 through 10, further comprising: identifying a first codeword-to-spatial layer mapping scheme, wherein the CSI is based at least in part on the identified first codeword-to-spatial layer mapping scheme; identifying a second codeword-to-spatial layer mapping scheme different from the first codeword-to-spatial layer mapping scheme; and generating second CSI, wherein the second CSI is based on the identified second codeword-to-spatial layer mapping scheme.
Aspect 12: The method of aspect 11, further comprising: transmitting the second CSI.
Aspect 13: The method of any of aspects 11 through 12, further comprising: transmitting signaling indicative of a difference between the CSI and the second CSI.
Aspect 14: The method of any of aspects 11 through 13, wherein one or more parameters included in the CSI are equal to one or more parameters included in the second CSI.
Aspect 15: The method of any of aspects 11 through 14, wherein the mapping between each codeword of the set of codewords and each spatial layer of the set of spatial layers is based on the CSI and the second CSI.
Aspect 16: A method for wireless communications at a network entity, comprising: transmitting a set of CSI-RSs; receiving CSI based at least in part on transmitting the set of CSI-RSs, the CSI comprising information that indicates an order of a set of spatial layers, wherein the order is based at least in part on relative signal strengths of the set of spatial layers; and receiving a set of codewords based at least in part on a mapping between each codeword of the set of codewords and each spatial layer of the set of spatial layers.
Aspect 17: The method of aspect 16, further comprising: transmitting a configuration that indicates a codeword-to-spatial layer mapping scheme, wherein the mapping between each codeword of the set of codewords and each spatial layer of the set of spatial layers is based at least in part on the transmitted configuration.
Aspect 18: The method of any of aspects 16 through 17, further comprising: receiving an indication of a codeword-to-spatial layer mapping scheme preferred by a UE, wherein the mapping between each codeword of the set of codewords and each spatial layer of the set of spatial layers is based at least in part on the received indication.
Aspect 19: The method of any of aspects 16 through 18, further comprising: receiving capability information that indicates a supported codeword-to-spatial layer mapping scheme, wherein the mapping between each codeword of the set of codewords and each spatial layer of the set of spatial layers is based at least in part on the received capability information.
Aspect 20: The method of any of aspects 16 through 19, further comprising: transmitting an indication to switch from a first codeword-to-spatial layer mapping scheme to a second codeword-to-spatial layer mapping scheme, wherein the mapping between each codeword of the set of codewords and each spatial layer of the set of spatial layers is based at least in part on the transmitted indication.
Aspect 21: The method of any of aspects 16 through 20, wherein the order indicates that a first spatial layer of the set of spatial layers is associated with a signal strength that is greater than a signal strength associated with a second spatial layer of the set of spatial layers.
Aspect 22: The method of aspect 21, wherein the order further indicates that a third spatial layer of the set of spatial layers is associated with a signal strength that is less than the signal strength associated with the first spatial layer and greater than the signal strength associated with the second spatial layer.
Aspect 23: The method of any of aspects 16 through 22, further comprising: receiving, during a first duration, a first portion of a codeword of the set of codewords; and receiving, during a second duration, a second portion of the codeword based at least in part on the received first portion of the codeword.
Aspect 24: The method of any of aspects 16 through 23, wherein the order indicates that a first spatial layer and a second spatial layer of the set of spatial layers are associated with a stronger signal strength compared to a signal strength of a third spatial layer and a fourth spatial layer of the set of spatial layers.
Aspect 25: The method of any of aspects 16 through 24, wherein the CSI corresponds to a first codeword-to-spatial layer mapping scheme, the method further comprising: receiving second CSI, wherein the second CSI corresponds to a second codeword-to-spatial layer mapping scheme.
Aspect 26: The method of aspect 25, wherein one or more parameters included in the CSI are equal to one or more parameters included in the second CSI.
Aspect 27: The method of any of aspects 25 through 26, wherein the mapping between each codeword of the set of codewords and each spatial layer of the set of spatial layers is based on the CSI and the second CSI.
Aspect 28: The method of any of aspects 16 through 27, wherein the CSI correspond to a first code-to-spatial layer mapping scheme, the method further comprising: receiving signaling indicative of a difference between the CSI and second CSI, wherein the second CSI corresponds to a second codeword-to-spatial layer mapping scheme.
Aspect 29: A UE for wireless communications, comprising one or more memories storing processor-executable code, and one or more processors coupled with the one or more memories and individually or collectively operable to execute the code to cause the UE to perform a method of any of aspects 1 through 15.
Aspect 30: A UE for wireless communications, comprising at least one means for performing a method of any of aspects 1 through 15.
Aspect 31: A non-transitory computer-readable medium storing code for wireless communications, the code comprising instructions executable by one or more processors to perform a method of any of aspects 1 through 15.
Aspect 32: A network entity for wireless communications, comprising one or more memories storing processor-executable code, and one or more processors coupled with the one or more memories and individually or collectively operable to execute the code to cause the network entity to perform a method of any of aspects 16 through 28.
Aspect 33: A network entity for wireless communications, comprising at least one means for performing a method of any of aspects 16 through 28.
Aspect 34: A non-transitory computer-readable medium storing code for wireless communications, the code comprising instructions executable by one or more processors to perform a method of any of aspects 16 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a set of channel state information reference signals;
transmit channel state information based at least in part on the received set of channel state information reference signals, the channel state information comprising information that indicates an order of a set of spatial layers, wherein the order is based at least in part on relative signal strengths associated with the set of spatial layers; and
transmit a set of codewords based at least in part on a mapping between each codeword of the set of codewords and each spatial layer of the set of spatial layers.

2. The UE of claim 1, wherein the one or more processors are individually or collectively further operable to execute the code to cause the UE to:
receive a configuration that indicates a codeword-to-spatial layer mapping, wherein the mapping between each codeword of the set of codewords and each spatial layer of the set of spatial layers is based at least in part on the received configuration.

3. The UE of claim 1, wherein the one or more processors are individually or collectively further operable to execute the code to cause the UE to:
select a codeword-to-spatial layer mapping scheme from a plurality of mapping schemes, wherein the mapping between each codeword of the set of codewords and each spatial layer of the set of spatial layers is based at least in part on the selected codeword-to-spatial layer mapping scheme; and
transmit an indication of the selected codeword-to-spatial layer mapping scheme.

4. The UE of claim 1, wherein the one or more processors are individually or collectively further operable to execute the code to cause the UE to:
transmit capability information that indicates a supported codeword-to-spatial layer mapping scheme, wherein the mapping between each codeword of the set of codewords and each spatial layer of the set of spatial layers is based at least in part on the transmitted capability information.

5. The UE of claim 1, wherein the one or more processors are individually or collectively further operable to execute the code to cause the UE to:
receive an indication to switch from a first codeword-to-spatial layer mapping scheme to a second codeword-to-spatial layer mapping scheme, wherein the mapping between each codeword of the set of codewords and each spatial layer of the set of spatial layers is based at least in part on the received indication.

6. The UE of claim 1, wherein the order indicates that a first spatial layer of the set of spatial layers is associated with a signal strength that is greater than a signal strength associated with a second spatial layer of the set of spatial layers.

7. The UE of claim 6, wherein the order further indicates that a third spatial layer of the set of spatial layers is associated with a signal strength that is less than the signal strength associated with the first spatial layer and greater than the signal strength associated with the second spatial layer.

8. The UE of claim 6, wherein, to transmit the set of codewords, the one or more processors are individually or collectively operable to execute the code to cause the UE to:
transmit, during a first duration, a first portion of a codeword of the set of codewords using the first spatial layer; and
transmit, during a second duration, the first portion of the codeword using the second spatial layer and a second portion of the codeword using the first spatial layer.

9. The UE of claim 1, wherein the order indicates that a first spatial layer and a second spatial layer of the set of spatial layers are associated with a stronger signal strength compared to a signal strength of a third spatial layer and a fourth spatial layer of the set of spatial layers.

10. The UE of claim 9, wherein, to transmit the set of codewords, the one or more processors are individually or collectively operable to execute the code to cause the UE to:
transmit, during a first duration, a first portion of a codeword of the set of codewords using the first spatial layer and the second spatial layer; and
transmit, during a second duration, the first portion of the codeword using the third spatial layer and the fourth spatial layer and a second portion of the codeword using the first spatial layer and the second spatial layer.

11. The UE of claim 1, wherein the one or more processors are individually or collectively further operable to execute the code to cause the UE to:
identify a first codeword-to-spatial layer mapping scheme, wherein the channel state information is based at least in part on the identified first codeword-to-spatial layer mapping scheme;
identify a second codeword-to-spatial layer mapping scheme different from the first codeword-to-spatial layer mapping scheme; and
generate second channel state information, wherein the second channel state information is based on the identified second codeword-to-spatial layer mapping scheme.

12. The UE of claim 11, wherein the one or more processors are individually or collectively further operable to execute the code to cause the UE to:
transmit the second channel state information.

13. The UE of claim 11, wherein the one or more processors are individually or collectively further operable to execute the code to cause the UE to:
transmit signaling indicative of a difference between the channel state information and the second channel state information.

14. The UE of claim 11, wherein one or more parameters included in the channel state information are equal to one or more parameters included in the second channel state information.

15. The UE of claim 11, wherein the mapping between each codeword of the set of codewords and each spatial layer of the set of spatial layers is based on the channel state information and the second channel state information.

16. A network entity, comprising:
one or more memories storing processor-executable code; and
one or more processors coupled with the one or more memories and individually or collectively operable to execute the code to cause the network entity to:
transmit a set of channel state information reference signals;
receive channel state information based at least in part on transmitting the set of channel state information reference signals, the channel state information comprising information that indicates an order of a set of spatial layers, wherein the order is based at least in part on relative signal strengths of the set of spatial layers; and
receive a set of codewords based at least in part on a mapping between each codeword of the set of codewords and each spatial layer of the set of spatial layers.

17. The network entity of claim 16, wherein the one or more processors are individually or collectively further operable to execute the code to cause the network entity to:
transmit a configuration that indicates a codeword-to-spatial layer mapping scheme, wherein the mapping between each codeword of the set of codewords and each spatial layer of the set of spatial layers is based at least in part on the transmitted configuration.

18. The network entity of claim 16, wherein the one or more processors are individually or collectively further operable to execute the code to cause the network entity to:
receive an indication of a codeword-to-spatial layer mapping scheme preferred by a user equipment (UE), wherein the mapping between each codeword of the set of codewords and each spatial layer of the set of spatial layers is based at least in part on the received indication.

19. The network entity of claim 16, wherein the one or more processors are individually or collectively further operable to execute the code to cause the network entity to:
receive capability information that indicates a supported codeword-to-spatial layer mapping scheme, wherein the mapping between each codeword of the set of codewords and each spatial layer of the set of spatial layers is based at least in part on the received capability information.

20. A method for wireless communications at a user equipment (UE), comprising:
receiving a set of channel state information reference signals;
transmitting channel state information based at least in part on the received set of channel state information reference signals, the channel state information comprising information that indicates an order of a set of spatial layers, wherein the order is based at least in part on relative signal strengths associated with the set of spatial layers; and
transmitting a set of codewords based at least in part on a mapping between each codeword of the set of codewords and each spatial layer of the set of spatial layers.
